(19) United States
(12) Patent Application Publication
(10) Pub. No.: US 2023/0337146 A1
(43) Pub. Date: Oct. 19, 2023

(54) WI-FI POWER-ADJUSTING METHOD AND DEVICE THEREOF

(71) Applicant: MEDIATEK INC., Hsinchu City (TW)

(72) Inventors: Wang-Hsin KUO, Hsinchu City (TW); Sheng-Kai CHANG, Hsinchu City (TW)

(21) Appl. No.: 17/720,901

(22) Filed: Apr. 14, 2022

(51) Int. Cl. H04W 52/28

(52) U.S. Cl. CPC H04W 52/283

(57) ABSTRACT

A Wi-Fi power-adjusting method is provided. The Wi-Fi power-adjusting method is applied to a Wi-Fi power-adjusting device. The Wi-Fi power-adjusting method includes the step of determining whether the Wi-Fi power-adjusting device is in a vehicle. When the Wi-Fi power-adjusting device is in the vehicle, the method adjusts the Wi-Fi Tx power of the Wi-Fi power-adjusting device based on a set value corresponding to the vehicle. The set value corresponds to the first power coverage of the Wi-Fi Tx power.

### BACKGROUND OF THE INVENTION

### Field of the Invention

The invention generally relates to a Wi-Fi power-adjusting technology, and more particularly, to a Wi-Fi power-adjusting method in which, when a Wi-Fi power-adjusting device is in a vehicle, the Wi-Fi power-adjusting device can make adjustments for its Wi-Fi Tx power based on a set value corresponding to the vehicle.

### Description of the Related Art

Portable Wi-Fi (e.g. a mobile Wi-Fi (MiFi)) may use a Wi-Fi tethering technique to share networks with a client device. Wi-Fi tethering is a basic functionality of mobile devices now. However, a mobile hotspot via Wi-Fi tethering may significantly increase the power consumption of the Wi-Fi tethering device.

In addition, Wi-Fi tethering functionality is also integrated into other systems, such as an In-Vehicle Infotainment system in an electric vehicle. In the case of an electric vehicle, the Wi-Fi tethering may draw power from the same battery used by the engine. Therefore, how to reduce the power consumption of the Wi-Fi tethering device is a topic that is worthy of discussion.

### BRIEF SUMMARY OF THE INVENTION

A Wi-Fi power-adjusting method and device are provided to overcome the problems mentioned above.

An embodiment of the invention provides a Wi-Fi power-adjusting method. The Wi-Fi power-adjusting method is applied to a Wi-Fi power-adjusting device. The Wi-Fi power-adjusting method includes the step of determining whether the Wi-Fi power-adjusting device is in a vehicle. When the Wi-Fi power-adjusting device is in the vehicle, the Wi-Fi Tx power of the Wi-Fi power-adjusting device is adjusted based on a set value corresponding to the vehicle. The set value corresponds to the first power coverage of the Wi-Fi Tx power.

An embodiment of the invention provides a Wi-Fi power-adjusting device. The Wi-Fi power-adjusting device may include a determining module and an adjusting module. The determining module determines whether the Wi-Fi power-adjusting device is in a vehicle. The adjusting module is coupled to the determining module. When the Wi-Fi power-adjusting device is in the vehicle, the adjusting module adjusts the Wi-Fi Tx power of the Wi-Fi power-adjusting device based on a set value corresponding to the vehicle, wherein the set value corresponds to the first power coverage of the Wi-Fi Tx power.

Other aspects and features of the invention will become apparent to those with ordinary skill in the art upon review of the following descriptions of specific embodiments of the Wi-Fi power-adjusting method and device.

### BRIEF DESCRIPTION OF THE DRAWINGS

The invention will become more fully understood by referring to the following detailed description with reference to the accompanying drawings, wherein:

FIG. 1 is a block diagram of a Wi-Fi power-adjusting system 100 according to an embodiment of the invention.

FIG. 2 is a flow chart illustrating a Wi-Fi power-adjusting method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

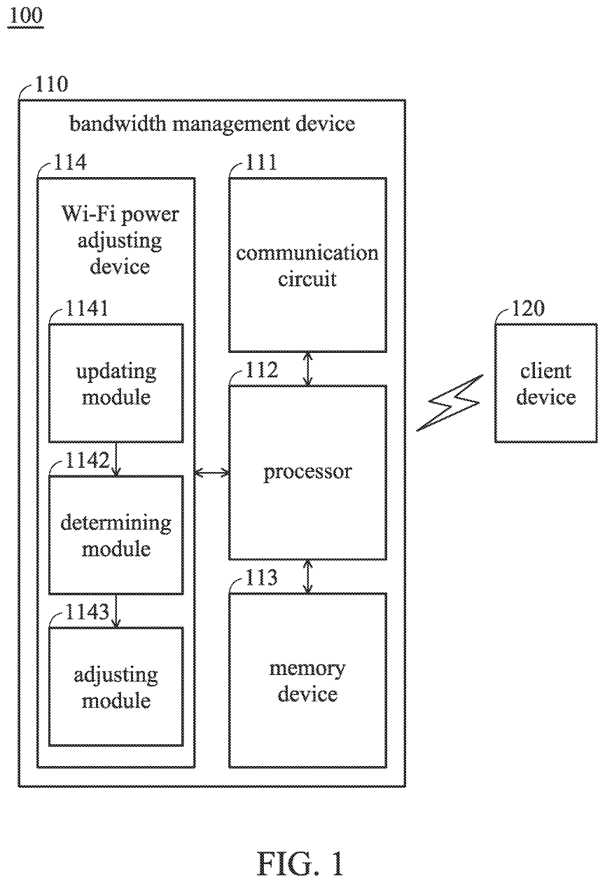

FIG. 1 is a block diagram of a Wi-Fi power-adjusting system 100 according to an embodiment of the invention. As shown in FIG. 1, the Wi-Fi power-adjusting system 100 may include a Wi-Fi power-adjusting device 110 and a client device 120. It should be noted that in order to clarify the concept of the invention, FIG. 1 presents a simplified block diagram in which only the elements relevant to the invention are shown. However, the invention should not be limited to what is shown in FIG. 1. The Wi-Fi power-adjusting system 100 may also comprise more client devices.

In the embodiments of the invention, the Wi-Fi power-adjusting device 110 may provide the interne connection to the client devices (e.g. the client device 120). The Wi-Fi power-adjusting device 110 may be a portable Wi-Fi (MiFi) device, but the invention should not be limited thereto.

In the embodiments of the invention, the client device 120 may be a user equipment (UE), e.g. a cell phone, a tablet computer, a notebook, but the invention should not be limited thereto.

As shown in FIG. 1, the Wi-Fi power-adjusting device 110 may include a communication circuit 111, a processor 112, a memory device 113 and a Wi-Fi power-adjusting module 114. It should be noted that in order to clarify the concept of the invention, FIG. 1 presents a simplified block diagram in which only the elements relevant to the invention are shown. However, the Wi-Fi power-adjusting device 110 should not be limited to what is shown in FIG. 1.

In the embodiments of the invention, the communication circuit 111 may comprise different network interfaces, e.g. Wi-Fi interface or Bluetooth interface, but the invention should not be limited thereto. The Wi-Fi power-adjusting device 110 may be connected to the client device 120 through the communication circuit 111. In addition, in the embodiments of the invention, the communication circuit 111 may further comprise at least one radio frequency (RF) module.

In the embodiments of the invention, the RF module may comprise a RF signal processing circuit and a baseband signal processing circuit. The RF signal processing circuit may receive RF signals via the antenna and process the received RF signals to convert the received RF signals to baseband signals to be processed by the baseband signal processing circuit, or receive baseband signals from the baseband signal processing circuit and convert the received baseband signals to RF signals to be transmitted to a peer communications apparatus. The RF signal processing circuit may comprise a plurality of hardware elements to perform radio frequency conversion. For example, the RF signal processing circuit may comprise a power amplifier, a mixer, analog-to-digital converter (ADC)/digital-to-analog converter (DAC), etc. The baseband signal processing circuit may further process the baseband signals to obtain information or data transmitted by the peer communications apparatus. The baseband signal processing circuit may also comprise a plurality of hardware elements to perform baseband signal processing.

In the embodiments of the invention, the processor 112 may control the operations of the communication circuit 111, the memory device 113 and the Wi-Fi power-adjusting module 114. According to an embodiment of the invention, the processor 112 may also be arranged to execute the program codes of the software modules. The program codes accompanied by specific data in a data structure may also be referred to as a processor logic unit or a stack instance when being executed. Therefore, in the embodiments of the invention, the processor 112 may be regarded as being comprised of a plurality of processor logic units, each for executing one or more specific functions or tasks of the corresponding software modules.

In the embodiments of the invention, the memory device 113 may store the software and firmware program codes, system data, user data, etc. of the Wi-Fi power-adjusting device 110. The memory device 113 may be a volatile memory such as a Random Access Memory (RAM); a non-volatile memory such as a flash memory or Read-Only Memory (ROM); a hard disk; or a combination thereof. The memory device 113 may store the parameters associated with the Wi-Fi Tx power adjustment of the Wi-Fi power-adjusting device 110 and store the set values corresponding to different environments (e.g. different vehicles, but the invention should not be limited thereto) corresponding to the Wi-Fi power-adjusting device 110.

In the embodiments of the invention, the Wi-Fi power-adjusting module 114 may comprise an updating module 1141, a determining module 1142 and an adjusting module 1143. The Wi-Fi power-adjusting module 114 can be implemented and configured by hardware, firmware, software, and any combination thereof. In some embodiments, the Wi-Fi power-adjusting module 114, when executed by the processor 112 (e.g., via executing program codes stores in memory device 113), allow the Wi-Fi power-adjusting device 110 to perform embodiments of the present invention.

In an embodiment of the invention, the updating module 1141 may update the parameters associated with the Wi-Fi Tx power adjustment of the Wi-Fi power-adjusting device 110. The parameters associated with the Wi-Fi Tx power adjustment of the Wi-Fi power-adjusting device 110 may comprise a moving parameter, a spatial parameter and a network parameter. The moving parameter may be the moving speed of the Wi-Fi power-adjusting device 110. The spatial parameter may be the size of the space in which the Wi-Fi power-adjusting device 110 is located. The network parameter may be a network ID corresponding to a vehicle, e.g. a Service Set Identifier (SSID) or the Bluetooth ID of a vehicle. The vehicle may establish a network connection with the Wi-Fi power-adjusting device 110 based on the network ID.

After the updating module 1141 updates the parameters associated with the Wi-Fi Tx power adjustment of the Wi-Fi power-adjusting device 110, the determining module 1142 may determine whether the updated parameters are changed. If the updated parameters are not changed, the adjusting module 1143 may maintain the Wi-Fi Tx power of the Wi-Fi power-adjusting device 110 within original power coverage.

If the updated parameters are changed, the determining module 1142 may determine whether the Wi-Fi power-adjusting device 110 is in a vehicle based on at least one of the updated parameters. When the determining module 1142 determines that the Wi-Fi power-adjusting device 110 is in a vehicle, the adjusting module 1143 may adjust the Wi-Fi Tx power of the Wi-Fi power-adjusting device 110 based on a set value corresponding to the vehicle, wherein the set value may correspond to the first power coverage of the Wi-Fi Tx power. Details for determining whether the Wi-Fi power-adjusting device 110 is in a vehicle will be discussed below.

In an embodiment of the invention, based on the updated moving parameter, the determining module 1142 may determine whether the moving speed of the Wi-Fi power-adjusting device 110 is higher than a threshold to determine whether the Wi-Fi power-adjusting device 110 is in a vehicle. When the determining module 1142 determines that the moving speed of the Wi-Fi power-adjusting device 110 is higher than the threshold, the determining module 1142 may determine that the Wi-Fi power-adjusting device 110 is in a vehicle. Therefore, the adjusting module 1143 will adjust its Wi-Fi Tx power based on a set value corresponding to the vehicle. When the determining module 1142 determines that the moving speed of the Wi-Fi power-adjusting device 110 is not higher than the threshold, the adjusting module 1143 may maintain the Wi-Fi Tx power of the Wi-Fi power-adjusting device 110 within original power coverage.

In another embodiment, based on the updated moving parameter, the determining module 1142 may identify the size of the space in which the Wi-Fi power-adjusting device 110 is located to determine whether the Wi-Fi power-adjusting device 110 is in a vehicle. When the determining module 1142 identifies that the size of the space satisfies certain conditions relating to the space corresponding to a particular vehicle, the determining module 1142 may determine that the Wi-Fi power-adjusting device 110 is in the vehicle. Therefore, the adjusting module 1143 will adjust its Wi-Fi Tx power based on a set value corresponding to the vehicle. If the determining module 1142 determines that the size of the space does not satisfy the aforementioned conditions, the adjusting module 1143 may maintain the Wi-Fi Tx power of the Wi-Fi power-adjusting device 110.

According to an embodiment of the invention, the determining module 1142 may identify the size of the space in which the Wi-Fi power-adjusting device 110 is located based on a ranging method, e.g. an infrared (IR) ranging method, a Received Signal Strength Indication (RSSI) ranging method, a Round-Trip Time (RTT) ranging method, a Neighborhood Aware Networking (NAN) ranging method, a RADAR ranging method, an Ultra-wideband (UWB) ranging method, or an Ultrasonic ranging method, but the invention should not be limited thereto.

In another embodiment, based on the updated moving parameter, the determining module 1142 may identify whether a network ID corresponds to a vehicle to determine whether the Wi-Fi power-adjusting device 110 is in a vehicle. In an embodiment, if the network ID is the Bluetooth ID of a vehicle, when the vehicle establishes a Bluetooth connection with the Wi-Fi power-adjusting device 110 based on the Bluetooth ID, the determining module 1142 may determine or identify whether the Bluetooth ID belongs to the vehicle. When the determining module 1142 determines that the Bluetooth ID belongs to the vehicle, the determining module 1142 may determine that the Wi-Fi power-adjusting device 110 is in the vehicle. In another embodiment, if the network ID is the SSID of a vehicle, when the vehicle establishes a Wi-Fi connection with the Wi-Fi power-adjusting device 110 based on the SSID, the determining module 1142 may determine or identify whether the SSID belongs to the vehicle. When the determining module 1142 determines that the SSID belongs to the vehicle, the determining module 1142 may determine that the Wi-Fi power-adjusting device 110 is in the vehicle. When the determining module 1142 determines that a network ID corresponds to a vehicle, the determining module 1142 may determine that the Wi-Fi power-adjusting device 110 is in the vehicle. Therefore, the adjusting module 1143 will adjust its Wi-Fi Tx power based on a set value corresponding to the vehicle. When the determining module 1142 determines that a network ID does not correspond to a vehicle, the adjusting module 1143 may maintain the Wi-Fi Tx power of the Wi-Fi power-adjusting device 110 within original power coverage.

According to an embodiment of the invention, after the adjusting module 1143 adjusts the Wi-Fi Tx power of the Wi-Fi power-adjusting device 110 based on the set value corresponding to the vehicle, the adjusting module 1143 may further dynamically adjust the Wi-Fi Tx power of the Wi-Fi power-adjusting device 110 based on distances between the Wi-Fi power-adjusting device 110 and the client devices in the vehicle. The client devices can establish network connection with the Wi-Fi power-adjusting device 110. A second power coverage of the Wi-Fi Tx power of the Wi-Fi power-adjusting device 110 dynamically adjusted by the adjusting module 1143 based on distance information may be smaller than the first power coverage of the Wi-Fi Tx power corresponding to the set value of the vehicle. For example, in a vehicle, there are the Wi-Fi power-adjusting device 110 and a client device (e.g. client device 120). If the distance between the Wi-Fi power-adjusting device 110 and the client device is lower than the first power coverage, the adjusting module 1143 may decrease the Wi-Fi Tx power of the Wi-Fi power-adjusting device 110 to a second power coverage based on the distance between the Wi-Fi power-adjusting device 110 and the client device. If the distance between the Wi-Fi power-adjusting device 110 and the client device is higher than current second power coverage, the adjusting module 1143 may increase the Wi-Fi Tx power of the Wi-Fi power-adjusting device 110 based on the distance between the Wi-Fi power-adjusting device 110 and the client device, i.e. the second power coverage is increased, but still lower than the first power coverage.

In an embodiment of the invention, when the Wi-Fi power-adjusting device 110 is in a vehicle, a frequency of dynamically adjusting the Wi-Fi Tx power of the Wi-Fi power-adjusting device 110 based on the distance information is decreased, since the distances between the Wi-Fi power-adjusting device 110 and the client devices are limited to the space of the vehicle. In other words, when the Wi-Fi power-adjusting device 110 is in a vehicle, the number of the adjusting module 1143 dynamically adjusting the Wi-Fi Tx power of the Wi-Fi power-adjusting device 110 will be decreased.

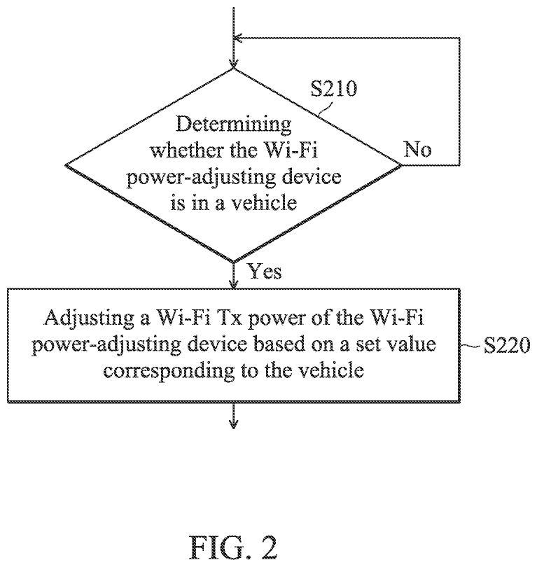

FIG. 2 is a flow chart illustrating a Wi-Fi power-adjusting method according to an embodiment of the invention. The Wi-Fi power-adjusting method can be applied to the Wi-Fi power-adjusting device 110. As shown in FIG. 2, in step S210, the Wi-Fi power-adjusting device 110 may determine whether the Wi-Fi power-adjusting device 110 is in a vehicle.

When the Wi-Fi power-adjusting device 110 is in the vehicle, step S220 is performed. In step S220, the Wi-Fi power-adjusting device 110 may adjusts the Wi-Fi Tx power of the Wi-Fi power-adjusting device 110 based on a set value corresponding to the vehicle, wherein the set value corresponds to the first power coverage of the Wi-Fi Tx power.

According to an embodiment of the invention, in step S210 of the Wi-Fi power-adjusting method, the Wi-Fi power-adjusting device 110 may determine whether the moving speed of the Wi-Fi power-adjusting device 110 is higher than a threshold to determine whether the Wi-Fi power-adjusting device 110 is in the vehicle. When the moving speed of the Wi-Fi power-adjusting device 110 is higher than the threshold, the Wi-Fi power-adjusting device 110 may determine the Wi-Fi power-adjusting device 110 is in the vehicle.

According to another embodiment of the invention, in step S210 of the Wi-Fi power-adjusting method, the Wi-Fi power-adjusting device 110 may identify the size of the space where the Wi-Fi power-adjusting device 110 is located in order to determine whether the Wi-Fi power-adjusting device 110 is in the vehicle. When the size of the space satisfies certain conditions relating to a specific space corresponding to the vehicle, the Wi-Fi power-adjusting device 110 determines that the Wi-Fi power-adjusting device 110 is in the vehicle. In the embodiment, the Wi-Fi power-adjusting device 110 may use a ranging method to identify the size of the space in which the Wi-Fi power-adjusting device 110 is located.

According to another embodiment of the invention, in step S210 of the Wi-Fi power-adjusting method, the Wi-Fi power-adjusting device 110 may determine whether a network ID corresponds to the vehicle to determine whether the Wi-Fi power-adjusting device 110 is in the vehicle, wherein the vehicle establishes a network connection with the Wi-Fi power-adjusting device 110 based on the network ID. When the network ID corresponds to the vehicle, the Wi-Fi power-adjusting device 110 may determine that the Wi-Fi power-adjusting device 110 is in the vehicle. In the embodiment, the network ID is a Service Set Identifier (SSID) or a Bluetooth ID.

According to an embodiment of the invention, in the Wi-Fi power-adjusting method, after the Wi-Fi power-adjusting device 110 adjusts the Wi-Fi Tx power of the Wi-Fi power-adjusting device 110 based on the set value corresponding to the vehicle, the Wi-Fi power-adjusting device 110 may further dynamically adjust the Wi-Fi Tx power of the Wi-Fi power-adjusting device 110 based on the distance between the Wi-Fi power-adjusting device 110 and at least one client device in the vehicle, wherein a second power coverage of the Wi-Fi Tx power generated after dynamically adjusting the Wi-Fi Tx power of the Wi-Fi power-adjusting device 110 based on the distance information is smaller than the first power coverage of the Wi-Fi Tx. In the embodiment, when the Wi-Fi power-adjusting device 110 is in the vehicle, a frequency of dynamically adjusting the Wi-Fi Tx power of the Wi-Fi power-adjusting device 110 based on the distance information is decreased.

In the Wi-Fi power-adjusting method provided in the invention, when the Wi-Fi power-adjusting device in a vehicle, the Wi-Fi Tx power of the Wi-Fi power-adjusting device can be adjusted based on a set value corresponding to the vehicle. Therefore, the power consumption will be reduced.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents. What is claimed is:
1. A Wi-Fi power-adjusting method, applied to a Wi-Fi power-adjusting device, comprising:
determining whether the Wi-Fi power-adjusting device is in a vehicle; and
when the Wi-Fi power-adjusting device is in the vehicle, adjusting a Wi-Fi Tx power of the Wi-Fi power-adjusting device based on a set value corresponding to the vehicle, wherein the set value corresponds to a first power coverage of the Wi-Fi Tx power.

2. The Wi-Fi power-adjusting method of claim 1, further comprising:
determining whether a moving speed of the Wi-Fi power-adjusting device is higher than a threshold to determine whether the Wi-Fi power-adjusting device is in the vehicle; and
when the moving speed of the Wi-Fi power-adjusting device is higher than the threshold, determining that the Wi-Fi power-adjusting device is in the vehicle.

3. The Wi-Fi power-adjusting method of claim 1, further comprising:
identifying a size of a space in which the Wi-Fi power-adjusting device is located to determine whether the Wi-Fi power-adjusting device is in the vehicle; and
when the size of the space satisfies a condition relating to a specific space of the vehicle, determining that the Wi-Fi power-adjusting device is in the vehicle.

4. The Wi-Fi power-adjusting method of claim 3, further comprising:
identifying the size of a space in which the Wi-Fi power-adjusting device is located based on a ranging method.

5. The Wi-Fi power-adjusting method of claim 1, further comprising:
determining whether a network ID corresponds to the vehicle to determine whether the Wi-Fi power-adjusting device is in the vehicle, wherein the vehicle establishes a network connection with the Wi-Fi power-adjusting device based on the network ID; and
when the network ID corresponds to the vehicle, determining that the Wi-Fi power-adjusting device is in the vehicle.

6. The Wi-Fi power-adjusting method of claim 5, wherein the network ID is a Service Set Identifier (SSID) or a Bluetooth ID.

7. The Wi-Fi power-adjusting method of claim 1, further comprising:
after adjusting the Wi-Fi Tx power of the Wi-Fi power-adjusting device based on the set value corresponding to the vehicle, dynamically adjusting the Wi-Fi Tx power of the Wi-Fi power-adjusting device based on a distance between the Wi-Fi power-adjusting device and at least one client device in the vehicle,
wherein a second power coverage of the Wi-Fi Tx power generated after dynamically adjusting the Wi-Fi Tx power of the Wi-Fi power-adjusting device based on the distance information is smaller than the first power coverage of the Wi-Fi Tx.

8. The Wi-Fi power-adjusting method of claim 7, wherein when the Wi-Fi power-adjusting device is in the vehicle, a frequency of dynamically adjusting the Wi-Fi Tx power of the Wi-Fi power-adjusting device based on the distance information is decreased.

9. A Wi-Fi power-adjusting device, comprising:
a determining module, determining whether the Wi-Fi power-adjusting device is in a vehicle; and
an adjusting module, coupled to the determining module and when the Wi-Fi power-adjusting device is in the vehicle, adjusting a Wi-Fi Tx power of the Wi-Fi power-adjusting device based on a set value corresponding to the vehicle, wherein the set value corresponds to a first power coverage of the Wi-Fi Tx power.

10. The Wi-Fi power-adjusting device of claim 9, wherein the determining module determines whether a speed of the Wi-Fi power-adjusting device is higher than a threshold to determine whether the Wi-Fi power-adjusting device is in the vehicle, wherein when the speed of the Wi-Fi power-adjusting device is higher than the threshold, the determining module determines that the Wi-Fi power-adjusting device is in the vehicle.

11. The Wi-Fi power-adjusting device of claim 9, wherein the determining module identifies a size of a space in which the Wi-Fi power-adjusting device is located to determine whether the Wi-Fi power-adjusting device is in the vehicle, wherein when the size of the space satisfies a condition relating to a specific space of the vehicle, the determining module determines that the Wi-Fi power-adjusting device is in the vehicle.

12. The Wi-Fi power-adjusting device of claim 11, wherein the determining module identifies the size of the space in which the Wi-Fi power-adjusting device is located based on a ranging method.

13. The Wi-Fi power-adjusting device of claim 9, wherein the determining module determines whether a network ID corresponds to the vehicle to determine whether the Wi-Fi power-adjusting device is in the vehicle, wherein the vehicle establishes a network connection with the Wi-Fi power-adjusting device based on the network ID, wherein when the network ID corresponds to the vehicle, the determining module determines that the Wi-Fi power-adjusting device is in the vehicle.

14. The Wi-Fi power-adjusting device of claim 13, wherein the network ID is a Service Set Identifier (SSID) or a Bluetooth ID

15. The Wi-Fi power-adjusting device of claim 9, wherein after the adjusting module adjusts the Wi-Fi Tx power of the Wi-Fi power-adjusting device based on the set value corresponding to the vehicle, the adjusting module further dynamically adjusts the Wi-Fi Tx power of the Wi-Fi power-adjusting device based on a distance between the Wi-Fi power-adjusting device and at least one client device in the vehicle, wherein a second power coverage of the Wi-Fi Tx power generated after dynamically adjusting the Wi-Fi Tx power of the Wi-Fi power-adjusting device based on the distance information is smaller than the first power coverage of the Wi-Fi Tx.

16. The Wi-Fi power-adjusting device of claim 15, wherein when the Wi-Fi power-adjusting device is in the vehicle, a frequency of dynamically adjusting the Wi-Fi Tx power of the Wi-Fi power-adjusting device based on the distance information is decreased.
